(19) United States
(12) Patent Application Publication
(10) Pub. No.: US 2012/0260494 A1
(43) Pub. Date: Oct. 18, 2012

(54) METHOD AND SYSTEM FOR SUPPORTING TO MAKE INVENTION

(75) Inventors: Itsuo Makino, Nomi-City (JP); Takaya Yuizono, Nomi-City (JP)

(73) Assignee: MAKINO KSAL COMPANY LIMITED, Nomi-City (JP)

(21) Appl. No.: 13/530,762

(22) Filed: Jun. 22, 2012

Related U.S. Application Data
(63) Continuation-in-part of application No. 12/951,720, filed on Nov. 22, 2010.

(51) Int. Cl. B23P 17/04

(52) U.S. Cl. 29/592

(57) ABSTRACT

Method and system for making an invention are disclosed. Invention spaces are provided to support one to make pioneer-type or improvement inventions. An imaginary invention space is formed based on two circles disposed at both ends of an axis respectively. Each of the circles is determined by the number of indispensable constituent elements of inventions relating to a product. The method according to the invention comprises step for determining a first construction of a product having a plurality of indispensable elements, step for determining a second construction of a product having at least one element of the plurality of the indispensable elements, and step for determining a third construction of a product having the at least one element of the indispensable elements for the second construction and at least one new element not included in the plurality of indispensable elements.

### FIELD OF THE INVENTION

The invention relates to a method and a system for supporting to make an invention. It supports to discover a technological problem or to solve a problem to make pioneer-type or improvement inventions. The invention is applicable to a product, an apparatus and technology. But, the invention as applied to a product will be hereinafter explained.

### BACKGROUND OF THE INVENTION

It has been known Theory of Inventive Problem Solving (TRIZ) invented by G. S. Altshuller for solving technological problems to produce inventions. Good patented inventions were analyzed to know processes how the inventions had been made. A vast number of patents were analyzed to invent TRIZ. But, the patents were used to devise the methodology of TRIZ. TRIZ classifies problems to be solved into five layers. The first layer includes problems to be solved by using knowledge individuals own. The second layer includes problems to be solved by using knowledge organizations own. The third layer includes problems to be solved by using documents or information in the one industrial field. With the fourth layer of problems, knowledge in the other industrial field is used to produce a new concept to solve a problem. The fifth layer relates to develop a fundamentally new system. TRIZ is effective for the second, third and fourth layers of problems.

It has been known by some patent practitioners and examiners that the scope of a claim defining an invention is determined based on an embodiment of an invention and prior art. FIG. 1 shows an invention protection model diagram explaining how an invention has been protected and how an invention has been evaluated in the United States. The protection model is explained in a publication ‘I. Makino, Lessons from Court Decisions Relating to Patent Infringement. In: Intellectual Properties (ChitekizaisankennoKoboniManabu Chitekizaisan), pp. 109-129, Kansai Electronic Industry Development Center (Kansai Denshikogyo Shinkosenta), Osaka Japan., 2000. (in Japanese)’ and in another publication ‘Thomas D. Brainard, “Patent Claim Construction: A Graphic Look”, Journal of the Patent & Trademark Office Society: pp 670-686 (2000).’

A small blue circle k1 represents an embodiment of an invention. An outer red circle K1 represents the broadest scope of protection obtained by an inventor with respect to the prior art. It is to be noted that the invention protection model has been used in filing a U.S. patent application to obtain a broader scope of protection for an invention, or in evaluating or determining the scope of an patented invention. It has also been known that a plurality of embodiments of an invention are covered with the outer red circle to provide the broadest scope of protection. It has been known that an apparatus, for instance, defined in a claim as an invention comprises a plurality of indispensable elements, i.e., a combination of a plurality of elements.

TRIZ uses existing knowledge to solve a technological problem, and teaches ways to make inventions. But, discovering a problem and solving the problem by using existing knowledge to make inventions are separated from each other and are not directly connected therebetween.

With the invention protection model, it is understood that the scope of a claim is defined as an invention and determined based on an embodiment of the invention and with respect to prior art, and thus can be broadened up to the prior art or up to one or some inventions which relates to patentability in terms of novelty or unobviousness, of the new invention and had been known. While, the present invention starts with the construction of an apparatus or technology currently used, and goes back along an imaginary time axis to the one of the first apparatus having been put on the market and then consider technological developments in the future to make inventions. With the Kutani Porcelain produced in Ishikawa Prefecture in Japan, for instance, the invention starts with the construction of a current Kutani Porcelain product, and goes back to porcelain products in an era about four-hundred years ago.

Accordingly, the present invention provides a new method and system for supporting to make inventions. It also provides a new method and system for making inventions. Attention is directed to the construction of a product, for instance, which embodies an invention comprising indispensable constituent elements, and to generalization used in filing a patent application to obtain a broader scope of protection with respect to prior art. The present invention is, particularly, applicable to solve problems as the first layer, the second layer and the third layer classified by TRIZ in the foregoing.

### SUMMARY OF THE INVENTION

An object of the present invention is to provide a method and a system for supporting to make a pioneer-type or an improvement inventions or for making inventions. There is used in producing an invention knowledge relating to patent or invention which has been used in obtaining a broader scope of protection for an invention or in evaluating the scope of invention such as generalization and illustrating an invention in a form of a circle the circumference of which is determined by the number of constituent elements of an invention.

One feature of the present invention is to provide a method for supporting to make an invention which comprises step for determining a first construction of a currently-used product having a plurality of constituent elements, step for illustrating the first construction of the product in a form of a circle, step for generalizing a plurality of times said first construction of the product to determine successively a plurality of (1st, 2, 3, . . . n-th) second constructions of the product, step for illustrating second constructions of the product in a form of circles with each circumference of the circles depending on the number of constituent elements of the constructions, and step for forming a cylindrical invention space based on at least one of the circles corresponding to the first construction of the currently-used product and the (1st, 2, 3, . . . (n-1)-th) second constructions, and the n-th circle which are disposed respectively on an imaginary straight line.

Another feature of the present invention is to provide the method for supporting to make an invention which further comprises step for producing an invention relating to one of the second constructions.

Another feature of the present invention is to provide the method for supporting to make an invention in which the first construction of a currently-used product is the construction of an embodiment according to an invention described in a patent publication.

Another feature of the present invention is to provide the method for supporting to make an invention which further comprises step for displaying the cylindrical invention space on the display screen of an indicator.

Another feature of the present invention is to provide the method for supporting to make an invention which further comprises step for determining a construction of a product having at least one new element not included in the n-th second construction.

Another feature of the present invention is to provide the method for supporting to make an invention which comprises step for determining a first construction of a currently-used product having a plurality of indispensable elements, step for generalizing said first construction to determine a second construction of a firstly-developed product having a plurality of the indispensable elements, and step for determining a third construction of a product having at least one element of the indispensable elements for the second construction and at least one new element not included in said plurality of indispensable elements in said second construction of the firstly-developed product.

Another feature of the present invention is to provide a method for making an invention which comprises step for determining a first construction having a plurality of indispensable elements, step for determining a second construction having at least one element of the plurality of the indispensable elements, and step for determining a third construction having said at least one element of the indispensable elements in the second construction and at least one new element not included in said plurality of indispensable elements of the first construction.

Another feature of the present invention is to provide a system for supporting to make an invention which comprises means for determining a first construction of a currently-used product having a plurality of indispensable elements, means for generalizing said first construction to determine a second construction of the firstly-developed product having a plurality of the indispensable elements, and means for determining a third construction of a product having at least one element of the indispensable elements for the second construction and at least one new element not included in said plurality of indispensable elements in said second construction of the firstly-developed product.

Another feature of the present invention is to provide a system for making an invention which comprises means for determining a first construction having a plurality of indispensable elements, means for determining a second construction having at least one element of the plurality of the indispensable elements, and means for determining a third construction having said at least one element of the indispensable elements in the second construction and at least one new element not included in said plurality of indispensable elements of the first construction.

Another feature of the present invention is to provide a method for assisting to make an invention which comprises first step for determining a first construction of a currently-used product having a plurality of indispensable elements, second step for generalizing a plurality of times said first construction of the product to determine successively a plurality of second constructions of the product, third step for selecting the most generalized third construction of the product out of said plurality of second constructions with the third construction having a plurality of indispensable elements, fourth step for determining fourth construction of the product having at least one element of the indispensable elements of the third construction, and fifth step for determining a fifth construction of a product having said at least one element of the indispensable elements in the fourth construction and at least one new element not included in said third construction.

Another feature of the present invention is to provide a method for assisting to make an invention comprising, step for determining a first construction of a currently-used product having a plurality of constituent elements, step for illustrating the first construction of the product in a form of a circle, step for generalizing a plurality of times said first construction of the product to determine successively a plurality of (2, 3, . . . n) second constructions of the product, step for illustrating said plurality of (2, 3, . . . n) second constructions of the product in a form of circles with each circumference of the circles depending on the number of constituent elements of the constructions, and step for forming a cylindrical invention space based on the first or the 2nd circle and the n-th circle disposed respectively on an imaginary straight line.

Another feature of the present invention is to provide a method for supporting to make an invention which comprises step for determining a first construction having a plurality of constituent elements, step for illustrating the first construction in a form of a circle, step for generalizing a plurality of times said first construction to determine successively a plurality of (1st, 2, 3, . . . n-th) second constructions, step for illustrating said plurality of (1st, 2, 3, . . . n-th) second constructions in a form of circles with each circumference of the circles depending on the number of constituent elements of the constructions, and step for forming a cylindrical invention space based on at least one of the circles corresponding to the first construction and the (1st, 2, 3, . . . (n-1)-th) second constructions, and the n-th circle disposed respectively on an imaginary straight line.

Another feature of the present invention is to provide a method for supporting to make an invention which comprises step for determining a first construction having a plurality of constituent elements, step for illustrating the first construction in a form of a circle, step for obtaining a plurality of (1st, 2, 3, . . . n-th) generalized second constructions, step for illustrating said plurality of (1st, 2, 3, . . . n-th) second constructions in a form of circles with each circumference of the circles depending on the number of constituent elements of the constructions, and step for forming a cylindrical invention space based on at least one of the circles corresponding to the first construction and (1st, 2, 3, . . . (n-1)-th) second constructions, and the n-th circle disposed respectively on an imaginary straight line.

Another feature of the present invention is to provide a method for supporting to make an invention which comprises step for determining a first construction having a plurality of indispensable elements, step for generalizing a plurality of times said first construction to determine successively a plurality of second constructions, step for selecting at least two constructions from the first construction and said plurality of second constructions, and step for forming an invention space based on the selected at least two constructions.

### BRIEF DESCRIPTION OF THE DRAWINGS

FIG. 1 shows an invention protection or evaluation model applicable, particularly to patent applications filed or patents issued in the United States;

FIG. 2 shows an invention space diagram for making a pioneer-type invention according to the present invention;

FIG. 3 shows a technological idea production process for structuring invention knowledge and producing an idea or an invention;

FIG. 4 shows relationship between invention protection and invention space for obtaining relevant knowledge and producing technological ideas;

FIG. 5 shows the invention space part of FIG. 4;

FIG. 6 shows a constructional arrangement of an embodiment according to the present invention.;

FIG. 7 shows another invention space for acquiring relevant knowledge and producing technological ideas; and

FIG. 8 shows a technological idea space formed based on constructions of a product or conceptual inventions obtained from patent publications.

### DETAILED DESCRIPTION OF THE INVENTION

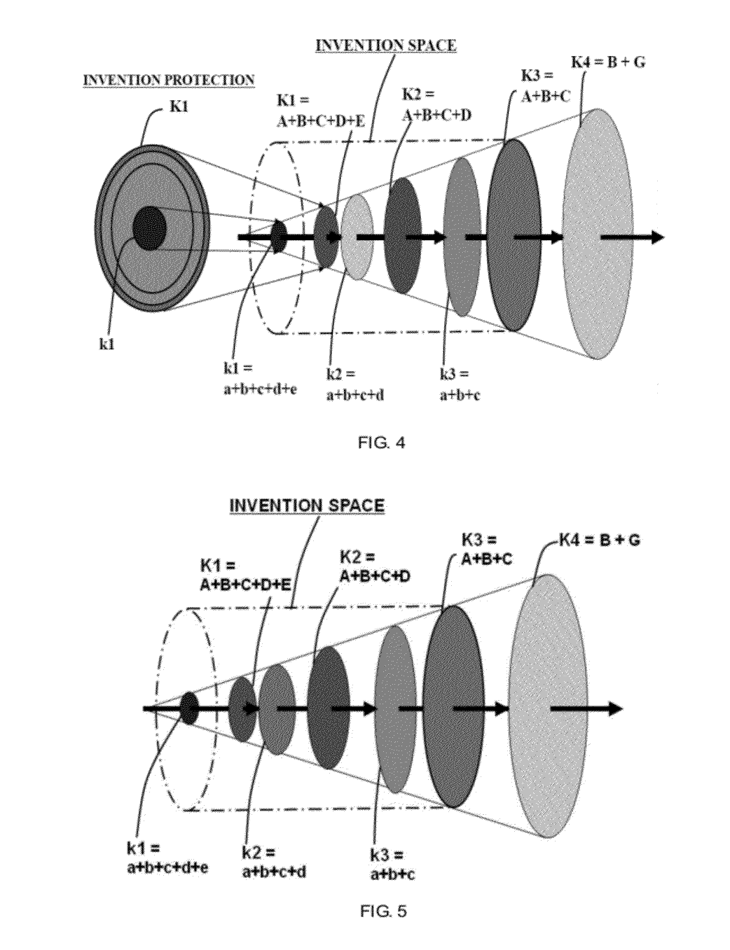

FIG. 2 shows an invention space diagram for making a pioneer-type invention. A three-dimensional invention space is made in a form of cylinder. The cylinder is determined by the circle T at the top, the circle V1 at the bottom which are disposed on an axis and the circumference of the circle T. The way to form the invention space shown in FIG. 2 is the same or almost the same as the one to form the invention spaces shown in FIGS. 4 and 5.

The generalized construction of, for instance, an apparatus is represented by a circle “V1” and is comprised with indispensable elements “A”, “B” and “C”. The circumference of the circle “V1” is determined by the number of elements “A”, “B” and “C”. The circle represented as “V1” is disposed on an axis on the left side as shown in FIG. 2. It is to be noted that an embodiment of an apparatus according to an invention (not shown) represented by “v1=a+b+c” is generalized to have “V1=A+B+C”. The construction represented by the circle “V1” is generalized to have a target construction of an apparatus represented by a circle “T” which is comprised with an indispensable element “A” of the generalized construction “V1”. The circle “T” is disposed on the axis on the right side as shown in FIG. 2. A cylindrical invention space is formed based on the circle “V1” and the circle “T”.

It is to be noted that the generalized construction of an apparatus represented by a circle “V1” will be obtained by generalizing the construction of a currently-used apparatus. The most generalized construction of a firstly-developed apparatus will be the construction K3 as shown in FIG. 4 or in FIG. 5. The construction K3 is used as V1 in FIG. 2.

Referring to the construction of an apparatus “V1” having a combination of the elements “A”, “B” and “C” and the other construction of an apparatus “T” having the element “A”, there will be produced an embodiment of an invention represented by “v211=A+y11” by adding to the element “A” included in “V1” an element “y11”. When the embodiment of an invention “v211” is generalized, it will be an invention claimed as “V211”. One element “A” of the three elements “A”, “B” and “C” is combined with the element “y11” to have an embodiment of an invention represented by “v211”, with the element “y11” not included in the construction represented by “V1=A+B+C”. It is to be noted that in the same way, one of the elements of y12, y13, . . . y1n is added to the element “A” to have an embodiment of another invention. The element “y11” corresponds to the embodiment of an invention “v211”. The elements of “y12, y13, . . . y1n” correspond to embodiments of the inventions “v212, v213, . . . v21n” respectively. When the embodiments of the inventions represented as “v212, v213, . . . v21n” are generalized, they will be inventions defined as “V212, V213, . . . V21n” respectively. Each of the inventions “V211, V212, V213, . . . V21n” will be disposed in the cylindrical invention space at a point therein close to the circle represented as “v2”.

In the same way, the construction represented by the circle “V1” is generalized to have a target construction of an apparatus represented by a circle “T” which is comprised with an indispensable element “B” of the generalized construction “V1“. The circle “T” is disposed on the axis on the right side as shown in FIG. 2.

Referring to the construction of an apparatus “V1” having a combination of the elements “A”, “B” and “C” and the other construction of an apparatus “T” having the element “B”, there will be produced an embodiment of an invention represented by “v221=B+y21” by adding to the element “B” included in “V1” an element “y21”. When the embodiment of an invention “v221” is generalized, it will be an invention claimed as “V221”. One element “B” of the three elements “A”, “B” and “C” is combined with the element “y21” to have an embodiment of an invention represented by “v221”, with the element “y21” not included in the construction represented by “V1=A+B+C”. It is to be noted that in the same way, one of the elements of y22, y23, . . . y2n is added to the element “B” to have an embodiment of another invention. The element “y21” corresponds to the embodiment of an invention “v221”. The elements of “y22, y23, . . . y2n” correspond to embodiments of the inventions “v222, v223, . . . v22n” respectively. When the embodiments of the inventions represented as “v222, v223, . . . v22n” are generalized, they will be inventions defined as “V222, V223, . . . V22n” respectively. Each of the inventions “V221, V222, V223, . . . V22n” will be disposed in the invention space at a point therein close to the circle represented as “v2”.

In the same way, the construction represented by the circle “V1” is generalized to have a target construction of an apparatus represented by a circle “T” which is comprised with an indispensable element “C” of the generalized construction “V1”. The circle “T” is disposed on the axis as shown in FIG. 2.

Referring to the construction of an apparatus “V1” having a combination of the elements “A”, “B” and “C” and the other construction of an apparatus “T” having the element “C”, there will be produced an embodiment of an invention represented by “v231=C+y31” by adding to the element “C” included in “V1” an element “y31”. When the embodiment of an invention “v231” is generalized, it will be an invention claimed as “V231”. One element “C” of the three elements “A”, “B” and “C” is combined with the element “y31” to have an embodiment of an invention represented by “v231”, with the element “y31” not included in the construction represented by “V1=A+B+C”. It is to be noted that in the same way, one of the elements of y32, y33, . . . y3n is added to the element “C” to have an embodiment of another invention. The element “y31” corresponds to the embodiment of an invention “v231”. The elements of “y32, y33, . . . y3n” correspond to embodiments of the inventions “v232, v233, . . . v23n” respectively. When the embodiments of the inventions represented as “v232, v233, . . . v23n” are generalized, they will be inventions defined as “V232, V233, . . . V23n” respectively. Each of the inventions “V231, V232, V233, . . . V23n” will be disposed in the invention space at a point therein close to the circle represented as “v2”.

Further, the construction represented by the circle “V1” is generalized to have a target construction of an apparatus represented by a circle “T” which is comprised with indispensable elements “A” and “B” of the generalized construction “V1”. The circle “T” is disposed on the axis as shown in FIG. 2.

Referring to the construction of an apparatus “V1” having a combination of the elements “A”, “B” and “C” and the other construction of an apparatus “T” having the elements “A” and “B”, there will be produced an embodiment of an invention represented by “v311=A+B+x11” by adding to a combination of the elements “A+B” included in “V1” an element “x11”. When the embodiment of an invention “v311” is generalized, it will be an invention claimed as “V311”. A combination of the elements “A+B” of the three elements “A”, “B” and “C” is combined with the element “x11” to have an embodiment of an invention represented by “v311”, with the element “x11” not included in the construction represented by “V1=A+B+C”. It is to be noted that in the same way, one of the elements of x12, x13, . . . x1n is added to the combination of the elements “A+B” to have an embodiment of another invention. The element “x11” corresponds to the embodiment of an invention “v311”. The elements of “x12, x13, . . . x1n” correspond to embodiments of the inventions “v312, v313, . . . v31n” respectively. When the embodiments of the inventions represented as “v312, v313, . . . v31n” are generalized, they will be inventions defined as “V312, V313, . . . V31n” respectively. Each of the inventions “V311, V312, V313, . . . V31n” will be disposed in the invention space at a point therein close to the circle represented as “v3”.

In the same way, the construction represented by the circle “V1” is generalized to have a target construction of an apparatus represented by a circle “T” which is comprised with indispensable elements “A” and “C” of the generalized construction “V1”. The circle “T” is disposed on the axis as shown in FIG. 2.

Referring to the construction of an apparatus “V1” having a combination of the elements “A”, “B” and “C” and the other construction of an apparatus “T” having the elements “A” and “C”, there will be produced an embodiment of an invention represented by “v321=A+C+x21” by adding to a combination of the elements “A+C” included in “V1” an element “x21”. When the embodiment of an invention “v321” is generalized, it will be an invention claimed as “V321”. A combination of the elements “A+C” of the three elements “A”, “B” and “C” is combined with the element “x21” to have an embodiment of an invention represented by “v321”, with the element “x21” not included in the construction represented by “V1=A+B+C”. It is to be noted that in the same way, one of the elements of x22, x23, . . . x2n is added to the combination of the elements “A+C” to have an embodiment of another invention. The element “x21” corresponds to the embodiment of an invention “v321”. The elements of “x22, x23, . . . x2n” correspond to embodiments of the inventions “v322, v323, . . . v32n” respectively. When the embodiments of the inventions represented as “v322, v323, . . . v32n” are generalized, they will be inventions defined as “V322, V323, . . . V32n” respectively. Each of the inventions “V321, V322, V323, . . . V32n” will be disposed in the invention space at a point therein close to the circle represented as “v3”.

It is also possible to generalize the construction represented by the circle “V1” to have a target construction of an apparatus represented by a circle “T” which is comprised with indispensable elements “B” and “C” of the generalized construction “V1”. In the same manner as explained above, there are produced inventions “V331, V332, V333, . . . V33n” which are disposed in the invention space at points therein close to the circle represented as “v3” respectively. Referring to FIG. 2, it is to be noted that the center of the circle “V1” and the center of the circle “T” are on the axis, but the center of the circles “v2” and “v3” will be displaced depending on added elements as “y” or “x” with respect to the axis, since elements “y” or “x” are added to the element “A”, with the elements “y” or “x” not included in the construction of an apparatus “V1”. The circles “v2” or “v3” are in the invention space in FIG. 2.

It is to be noted that the invention space shown in FIG. 2 is the same or almost the same as the invention space shown in FIG. 4 or FIG. 5 in terms of the construction or ways to obtain constructions in the invention space.

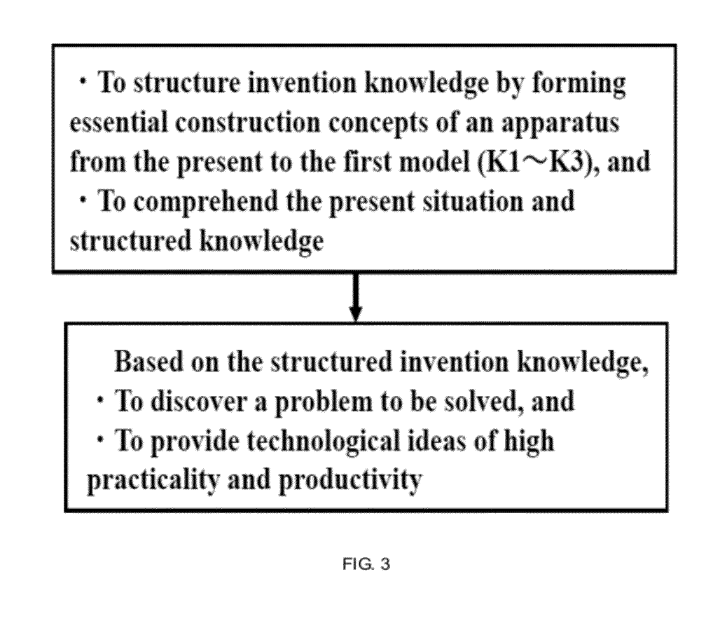

Referring to FIG. 3, flow diagram for the method and system according to the present invention will be explained. FIG. 3 shows a technological idea production process for structuring invention knowledge and producing an idea or an invention. Essential construction concepts of an apparatus are selectively and successively formed from the currently-used apparatus up to the firstly-developed apparatus to structure invention knowledge. Based on the structured invention knowledge and other information, a technological problem will be discovered, which will lead one to make improvement or new-use inventions. FIG. 3 shows a technological idea production process for structuring invention knowledge and producing an idea or an invention which relates to the invention spaces for producing improvement inventions shown in FIG. 4 and FIG. 5. It also relates to the invention space for producing pioneer-type inventions shown in FIG. 2.

Referring to FIG. 4, three circles are provided as K1, K2, and K3 showing generalized conceptual constructions. FIG. 4 shows relationship between invention protection and invention space. The circumference of a first red circle K1 is determined by five indispensable constituent elements A, B, C, D and E for an apparatus currently used. It has been known that the construction of an invention comprising some constituent elements is represented in a form of a circle, with the circumference thereof depending on the number of elements. The generalized conceptual construction K1, for instance, is obtained by generalizing the construction of a currently-used apparatus comprising constituent elements a, b, c, d and e (not shown). The construction of the currently-used apparatus is, for instance, described in specification and drawings of a patent publication currently published. The circumference of a second green circle K2 is obtained by generalizing the construction K1 and determined by four indispensable elements A, B, C and D for an apparatus manufactured at an older time instant.

The circle K2 corresponds to the construction of a product example k2. There are cases that the circle K2 is obtained by generalizing the construction k2.

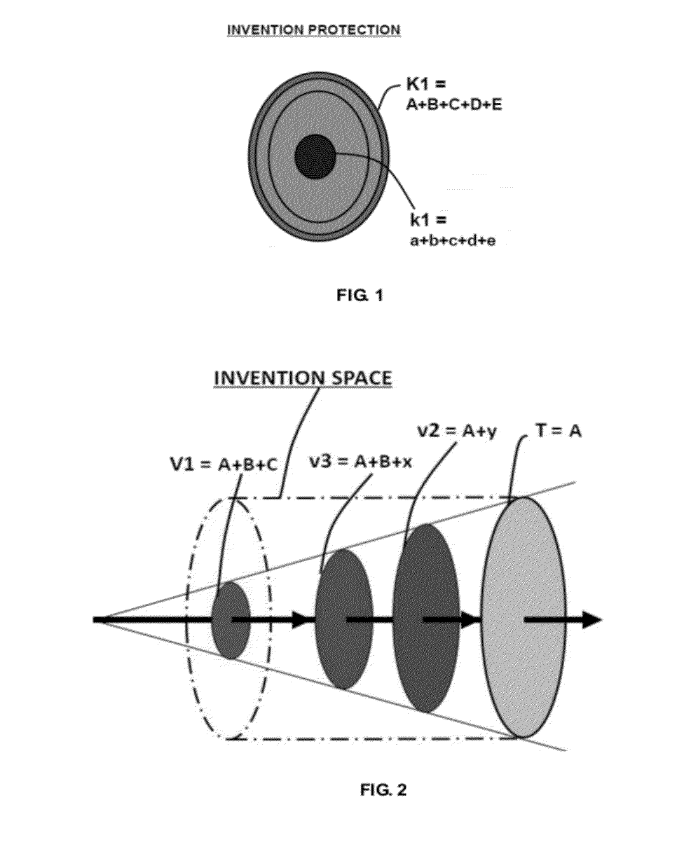

In the same way, the circumferences of a third purple circle K3 is obtained by generalization and determined by indispensable constituent elements A, B and C. The circumferences of a fourth yellow circle K4 is obtained by abstraction with respect to the circle K3 and determined by indispensable constituent elements B and G. It is to be noted that the outer red circle represented as “K1” shown in FIG. 1 is the same as the red circle represented as “K1” in FIG. 4. Thus, some patent practitioners have used a generalization based on an embodiment of an invention described in specification and drawings in filing a U.S. patent application to broaden the scope of a claim up to the circumference of the red circle represented as “K1” or “k2” at most in order to obtain a broader scope of protection for an invention. But, no further generalizations have been made beyond the circle K1, since they will not work to obtain a broader scope of protection.

FIG. 5 shows the invention space part of FIG. 4. A three-dimensional invention space is made in a form of cylinder. The cylinder is determined by the circle K3 at the top, the circle k1 at the bottom which are disposed on an axis and the circumference of the circle K3.

At first, the present construction of a product currently used is analyzed to determine indispensable elements thereof (k1), and then generalized to cover another example of product which functions in the same way as the present product (K1). The present construction of a product will be generalized also along a time axis up to the construction of the concept of the first product (K3) which was first put on the market. Between the present construction of a product (K1) and the construction of the product concept (K3), another generalization based on the present construction thereof is made at a time instant on the time axis (K2). In the same way, another generalization may be made along the time axis as required. The construction of a product and the generalized conceptual construction are represented in a form of circles. The circles representing constructions are disposed on an axis respectively. An invention space will be formed based on some of the circles.

The three-dimensional invention space is formed by structuring invention knowledge. Within the imaginary cylinder, technological problems to be solved will be discovered and a method or an apparatus to solve it will be devised and thus, inventions will be made.

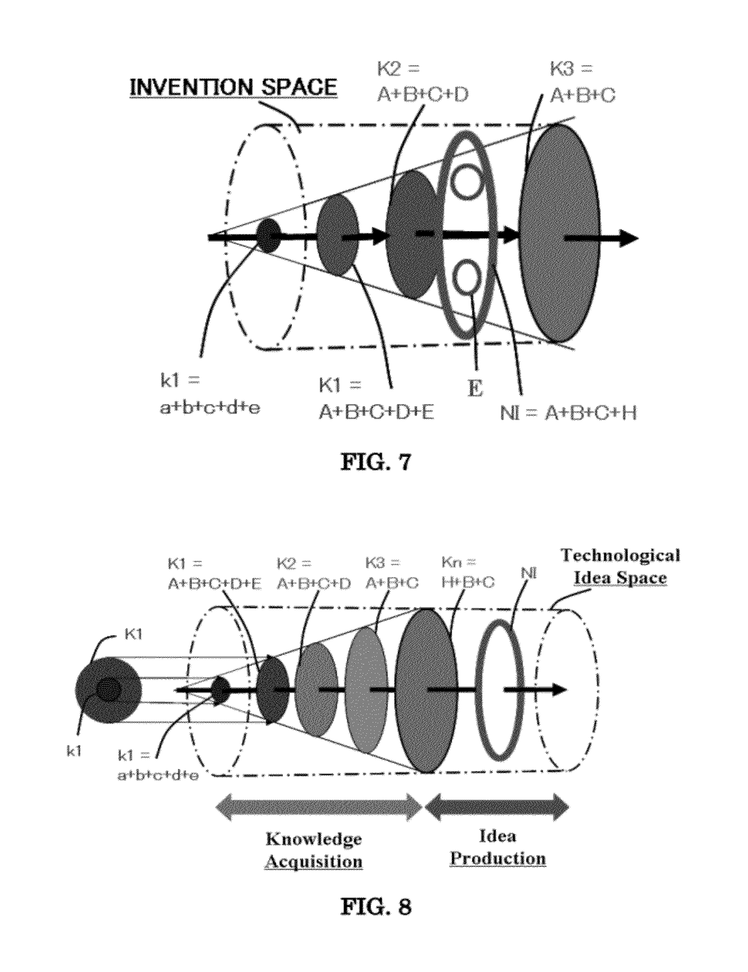

Referring to FIG. 7, there is seen the construction (k1) of a product which is currently used or is an embodiment of an invention described in a patent publication. The construction (k1) is generalized successively to have conceptual invention constructions as K1, K2 and K3. The invention space is formed based on the construction k1 at the left end on an axis and the construction K3 at the right end thereon. Another concept construction NI is devised. The construction NI is an invention. The inventive construction NI will lead one or provide one with motivation to devise the construction of a product, an embodiment of the invention. Thus, a technological idea or a construction to form an invention is produced relating to a concept construction NI in the invention space.

Referring to FIG. 8, four circles are disposed on a time axis as K1, K2, K3 and Kn respectively showing generalized or abstracted conceptual constructions which are obtained from patent information including patent publications. The small blue circle k1 represents the construction of the fundamental embodiment of an invention relating to a centerless grinder described in a patent application. The circumference of a first brown circle K1 is obtained by generalizing the construction of the grinder comprising constituent elements a, b, c, d and e described in the patent publication and determined by five indispensable constituent elements A, B, C, D and E for the centerless grinder currently used and described in a patent claim of the patent publication. The green circle K2, blue circle K3 are obtained from descriptions from the patent publication and patent information between an examiner and the patent applicant produced during the examination in the Patent Office. The purple circle Kn comprising elements H, B and C is obtained from documents relating thereto. A threedimensional technological idea space is made in a form of cylinder. The cylinder is determined by the circle Kn at the top, the circle k1 at the bottom and the circumference of the circle Kn.

Idea Production:

During six months for our activities with a project, we made experiments to see whether the idea production method with the technological knowledge acquisition method helps students or engineers to produce ideas about an apparatus about which the experiment participants have no relevant knowledge.

Test on technological knowledge acquisition method utilizing patent data in a technological space:
a) Number of students and engineers participated in the experiment: Four students and one engineer;
b) Apparatus worked on: Centerless Grinder;
c) Documents used: Table 1 shows the relationship between invention concept forming steps and relevant documents collected. There are included patent application publications and patents which a company developing and manufacturing a centerless grinder in the local society had filed at the Japanese Patent Office, and search reports about a registered invention. Twelve patent publications belong to the company in the local society. Seven patent publications were cited by the examiner and used to determine the construction of an invention concept K2;

TABLE 1
Concept Forming Steps and Publications

| Steps | Documents studied |
|---|---|
| k1 | Construction of invention embodiment of |
| | JPA2003-191153 |
| K1 | Patent Claim of JPA2003-191153 |
| K2 | Conventional apparatus described in |
| | JPA2003-191153. Seven cited patent |
| | publications |
| K3 | Other ten patent publications filed by the |
| | applicant for JPA2003-191153 |
| K4 | Definition of the centerless grinder |
| Kn | Mechanical grinders |

d) Time given to and used by participants: Six meetings were used to understand the construction and operation of the inventions described in nineteen patent publications relating to the centerless grinder we worked on. We had one meeting lasting 1.5 hours every week. The participants read and understood assigned patent publications beforehand, and explained about inventions to other participants at the meeting in turn; and
e) Result: When we started to work on the centerles grinder, we could not produce any ideas since all the participants had no relevant knowledge. After the relevant patent publications were read and understood, ten ideas were produced by the participants.

Experiment:

An experiment was conducted in the following way. The experiment corresponds to the technological idea production process for structuring invention knowledge and producing an idea or an invention shown in FIG. 3 and also to the invention spaces shown in FIG. 4 and FIG. 5.

Subjects: Patent professionals, Members of Intellectual Property Subcommittee in Kansai Electronic Industry Development Center (KEC),

Reason: Accustomed to make documents requiring a combination of technological elements. But, not required to develop new technology or to make inventions,

Number of subjects: Eight persons,

Explanation about the experiment was made at KEC's meeting held in Nomi-City in 2009, and

Experiments were made respectively at places the subjects like. Answers to questions were received to obtain experiment data.

An experiment was made on a vending machine with unwanted sound reducer to see the effectiveness of the proposed method relating to the present invention for structuring invention knowledge to produce technological ideas. We received from eight participants belonging to KEC experiment results and completed questionnaires.

Experiment Procedure:

Eight participants are divided into two groups. All of the eight participants are allowed to make searches to refer to any kinds of information and documents. The first group used the proposed method to produce ideas, while the second group produced technological ideas in their own ways without using the proposed method.

To the First Group

We explained our proposed method to the first group for structuring invention knowledge to produce technological ideas. We presented the first group with an unexamined Japanese patent application publication No. 2009-237719 with its title “A feedback-type active sound reducer and vending machine” and the questionnaire. We asked the members of the first group to read the publication, and to make improvement inventions or any kinds of inventions to produce ideas to solve problems they may have or discover.

To the Second Group

We presented the second group with a letter explaining the experiment method and the unexamined patent application publication No. 2009-237719 and the questionnaire. We asked the members of the second group to read the publication, and to make improvement inventions or any kinds of inventions to produce ideas to solve problems they may have or discover.

The four participants of the first group described a plurality of essential construction concepts of a vending machine with unwanted sound reducer. As an example, the following shows a series of essential construction concepts formed by a participant of a vending machine with unwanted sound reducer. The four constructions of the series of essential construction concepts can be put respectively into cells forming a chart and displayed on the screen of an indicator.

Construction of Current Machine:

A vending machine with unwanted sound reducer comprising:

a compressor for adjusting temperature,

a microphone for detecting unwanted sounds,

a speaker for producing control sounds,

means for generating control sound signals to generate control sound signals,

detection means for detecting unwanted sounds above a predetermined level, and

a controller for controlling the means for generating control sound signals in response to an output from the detection means.

Construction Concept 1:

A vending machine with unwanted sound reducer comprising:

a compressor for adjusting temperature,

a microphone for detecting unwanted sounds,

a speaker for producing control sounds, and

means for generating control sound signals to generate control sound signals.

Construction Concept 2:

An unwanted sound reducer comprising:

a microphone for detecting unwanted sounds,

a speaker for producing control sounds, and

means for generating control sound signals to generate control sound signals.

Construction Concept n:

An unwanted sound reducer for reducing unwanted sounds by using sounds having 180 degrees out of phase with respect to the unwanted sounds.

Ten technological ideas were presented by the four participants A, B, C and D in the first group. While, eighteen ideas were presented by the four participants E, F, G and H in the second group. Each idea is evaluated by the three evaluators with one of three, “F” having 5 points, “J” having 3 points and “K” having 1 point. For each idea presented, evaluation values given by the three evaluators are summed to be a total value in terms of six evaluation items as Originality, Practicality, Feasibility, Productivity, Inclusiveness and lnsightfulness. It is to be noted that the evaluation items are taken from “Creative Cognition” by R. A. Finke et al.

Evaluation comparison between the first and second groups is made and its result is shown as Table 2 in the following.

There are shown average values of the ideas presented by the first group using the proposed method and by the second group producing their ideas in their own ways. A t-test is made on evaluation values.

As a result of the t-test and as seen in the Table 2, the ideas presented by the first group using the proposed method are more advantageous or preferable than the ones presented by the second group producing their ideas in their own ways in terms of five evaluation items as practicality, feasibility, productivity, inclusiveness and insightfulness.

TABLE 2
Idea Comparison between First and Second Groups

| | | | | | | In- |
|---|---|---|---|---|---|---|
| Evaluation | Origi- | Practi- | Feasi- | Produc- | Inclusive- | sightful- |
| item | nality | cality* | bility* | tivity* | ness* | ness* |
| First G. with | 9.8 | 13.0 | 11.8 | 12.4 | 12.2 | 12.2 |
| Proposed | | | | | | |
| Method | | | | | | |
| Second G. | 10.7 | 8.4 | 9.0 | 7.9 | 8.7 | 9.1 |
| without the | | | | | | |
| Method | | | | | | |

T-test: * p < 0.05

With Table 2 for the first group using the proposed method and for the second group not using the method, it is thought that the first group structured invention knowledge to form the cylindrical invention space, and found relevant knowledge, information and technological problems in the invention space. It is thought that the invention space helped the participants of the first group to produce ideas of higher evaluation values in terms of evaluation items such as practicality and productivity. It is to be noted that eight technological ideas out of the ten ideas presented by the first group relates to vending machines with unwanted sound reducer. It is thought that these eight ideas are produced in the invention space determined by the plurality of the essential construction concepts formed.

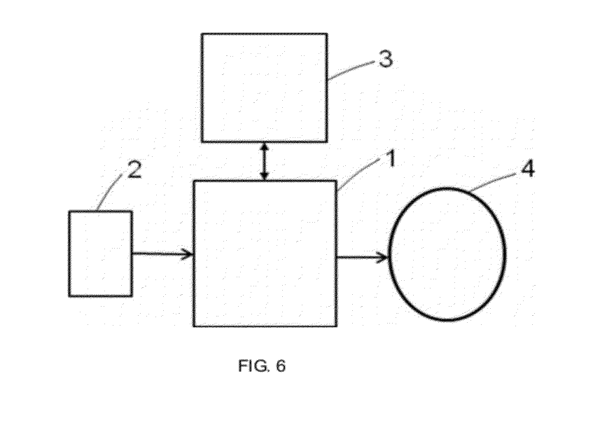

FIG. 6 shows a constructional arrangement of a system to assist one to make inventions, which is an embodiment of the present invention.

Referring to FIG. 6, a microprocessor 1 is connected to an input device 2 and to a memory unit 3 and to a display device 4. The input device supplies the microprocessor 1 with kinds of data such as operational data for controlling the microprocessor 1 or data for display or data to be maintained in the memory unit 3. The memory unit 3 stores digital signals corresponding to and relating to data, texts, drawings, pictures for displaying on the screen of the display device 4, for example, each of the invention spaces as shown in FIG. 2, FIG. 4, FIG. 5, FIG. 7 and FIG. 8 and a chart having cells to present or to receive essential construction concepts respectively. The microprocessor 1 operates automatically in accordance with programs having been stored therein or in response to operational data received from the input device 2. The microprocessor 1 processes data received from the input device 2 and from the memory unit 3 to provide the display device 4 with display signals. The display device 4 presents one with displays according to the technological idea production process as shown in FIG. 3 provided by the present invention. The display device 4 displays texts, pictures, drawings, the flow for structuring invention knowledge shown in FIG. 3, each of the invention spaces shown in FIG. 2, FIG. 4, FIG. 5, FIG. 7 and FIG. 8, an integrated invention space having the invention space shown in FIG. 2 and the invention space shown in FIG. 5 connected with each other. It also displays a chart having grids or cells for having, or receiving and displaying constructions of inventions or products therein, and the like. These displays are useful, helpful and used in acquiring relevant knowledge and producing technological ideas. An operator interacts with the system so that desirous information for producing ideas will be displayed and seen. A display of essential construction concepts of a product in corresponding cells in a chart will also lead the operator to discover problems or solve problems to make inventions. The system shown in FIG. 6 is linked to patent databases provided by the Patent Offices as the United States and Japan so that a patent publication is obtained through the internet network and is wholly or partly displayed on the display device 4 as desired.

Although it has been explained that the invention space shown in FIG. 2 is used for making pioneer-type inventions and that the invention space shown in FIG. 4 and in FIG. 5 is used for making improvement inventions, it is possible to connect the invention space in FIG. 4 or FIG. 5 or FIG. 7 with the invention space shown in FIG. 2. When these two invention spaces are combined, the circle represented by “K3” in FIG. 4 or FIG. 5 or FIG. 7 will be the circle “V1” shown in FIG. 2. Knowledge and information obtained in exploring the invention space in FIG. 4, FIG. 5, and FIG. 7 will be usefully used in making inventions in the invention space shown in FIG. 2. These knowledge and information will increase the number of problem discoveries and of means for solving problems.

With an invention space, the construction of a product or a technology which is currently used or described in a patent publication is generalized to obtain a plurality of constructions thereof as k1, K1, K2 . . . Kn. It is also possible to use some generalized constructions as K2 and K3 to form an invention space.

Although the present invention has been particularly shown and described with reference to example embodiments of the invention, it will be understood by those skilled in the art that various changes in form and details may be made without departing from the scope of the invention encompassed by the appended claims.

What is claimed is:

1. Method for supporting to make an invention comprising:
step for determining a first construction of a currently-used product having a plurality of constituent elements;
step for illustrating the first construction of the product in a form of a circle;
step for generalizing a plurality of times said first construction of the product to determine successively a plurality of (1st, 2, 3, . . . n-th) second constructions of the product;
step for illustrating said plurality of (1st, 2, 3, . . . n-th) second constructions of the product in a form of circles with each circumference of the circles depending on the number of constituent elements of the constructions; and
step for forming a cylindrical invention space based on at least one of the circles corresponding to the first construction of the currently-used product and the (1st, 2, 3, . . . (n-1)-th) second constructions, and the n-th circle which are disposed respectively on an imaginary straight line.

2. Method for supporting to make an invention of claim 1 further comprising step for producing an invention relating to one of the second constructions.

3. Method for supporting to make an invention of claim 1 further comprising step for displaying the cylindrical invention space on the display screen of an indicator.

4. Method for supporting to make an invention of claim 1 further comprising step for providing a construction of a product having at least one new element not included in the 1st second construction.

5. The method for supporting to make an invention of claim 2 wherein the first construction of a currently-used product is the construction of an embodiment according to an invention described in a patent publication.

6. The method for supporting to make an invention of claim 2 wherein the 1st second construction is the one of an invention defined in a claim having the broadest protection scope described in a patent publication.

7. The method for supporting to make an invention of claim 1 further comprising step for determining a construction of a product having at least one new element not included in the n-th second construction.

8. The method for supporting to make an invention of claim 4 wherein the first construction of a currently-used product is the construction of an embodiment according to an invention described in a patent publication.

9. The method for supporting to make an invention of claim 5 wherein the 1st second construction is the one of an invention defined in a claim having the broadest protection scope described in a patent publication.

10. Method for supporting to make an invention comprising:
step for determining a first construction of a currently-used product having a plurality of indispensable elements;
step for generalizing said first construction to determine a second construction of a firstly-developed product having a plurality of the indispensable elements; and
step for determining a third construction of a product having at least one element of the indispensable elements for the second construction and at least one new element not included in said plurality of indispensable elements in said second construction of the firstly-developed product.

11. Method for making an invention comprising:
step for determining a first construction having a plurality of indispensable elements;
step for determining a second construction having at least one element of the plurality of the indispensable elements; and
step for determining a third construction having said at least one element of the indispensable elements in the second construction and at least one new element not included in said plurality of indispensable elements of the first construction.

12. Method for making an invention of claim 11 wherein each of the constructions is of a product.

13. Method for making an invention of claim 11 wherein each of the constructions is a technological construction.

14. Method for making an invention of claim 11 wherein the second construction comprises a lesser number of indispensable elements with respect to the one of the first construction and third construction comprises indispensable elements the number of which being between the one of the first construction and the one of the second construction.

15. Method for making an invention of claim 14 wherein the first construction is determined based on the construction of an embodiment according to an invention described in a patent publication.

16. System for supporting to make an invention comprising:
means for determining a first construction of a currently-used product having a plurality of indispensable elements;
means for generalizing said first construction to determine a second construction of the firstly-developed product having a plurality of the indispensable elements; and
means for determining a third construction of a product having at least one element of the indispensable elements for the second construction and at least one new element not included in said plurality of indispensable elements in said second construction of the firstly-developed product.

17. System for making an invention comprising:
means for determining a first construction having a plurality of indispensable elements;
means for determining a second construction having at least one element of the plurality of the indispensable elements; and
means for determining a third construction having said at least one element of the indispensable elements in the second construction and at least one new element not included in said plurality of indispensable elements of the first construction.

18. System for making an invention of claim 17 wherein the first construction is determined based on the construction of an embodiment according to an invention described in a patent publication.

19. System for making an invention of claim 17 wherein the first construction is the most generalized construction of firstly-developed product obtained by generalizing the construction of an embodiment according to the invention described in a patent publication.

20. Method for assisting to make an invention comprising:
first step for determining a first construction of a currently-used product having a plurality of indispensable elements;
second step for generalizing a plurality of times said first construction of the product to determine successively a plurality of second constructions of the product;
third step for selecting the most generalized third construction of the product out of said plurality of second constructions with the third construction having a plurality of indispensable elements;
fourth step for determining fourth construction of the product having at least one element of the indispensable elements of the third construction; and
fifth step for determining a fifth construction of a product having said at least one element of the indispensable elements in the fourth construction and at least one new element not included in said third construction.

21. Method for assisting to make an invention comprising:
step for determining a first construction of a currently-used product having a plurality of constituent elements;
step for illustrating the first construction of the product in a form of a circle;
step for generalizing a plurality of times said first construction of the product to determine successively a plurality of (2, 3, . . . n) second constructions of the product;
step for illustrating said plurality of (2, 3, . . . n) second constructions of the product in a form of circles with each circumference of the circles depending on the number of constituent elements of the constructions; and
step for forming a cylindrical invention space based on the first or the 2nd circle and the n-th circle disposed respectively on an imaginary straight line.

22. The method for supporting to make an invention of claim 21 wherein the first construction of a currently-used product is the construction of an embodiment according to an invention described in a patent publication.

23. Method for supporting to make an invention comprising:
step for determining a first construction having a plurality of constituent elements;
step for illustrating the first construction in a form of a circle;
step for generalizing a plurality of times said first construction to determine successively a plurality of (1st, 2, 3, . . . n-th) second constructions;
step for illustrating said plurality of (1st, 2, 3, . . . n-th) second constructions in a form of circles with each circumference of the circles depending on the number of constituent elements of the constructions; and
step for forming a cylindrical invention space based on at least one of the circles corresponding to the first construction and (1st, 2, 3, . . . (n-1)-th) second constructions, and the n-th circle disposed respectively on an imaginary straight line.

24. Method for supporting to make an invention of claim 23 further comprising step for producing an invention relating to one of the second constructions.

25. Method for supporting to make an invention of claim 23 further comprising step for displaying the invention space on the display screen of an indicator.

26. Method for supporting to make an invention comprising:
step for determining a first construction having a plurality of constituent elements;
step for illustrating the first construction in a form of a circle;
step for obtaining a plurality of (1st, 2, 3, . . . n-th) generalized second constructions;
step for illustrating said plurality of (1st, 2, 3, . . . n-th) second constructions in a form of circles with each circumference of the circles depending on the number of constituent elements of the constructions; and
step for forming a cylindrical invention space based on at least one of the circles corresponding to the first construction and the (1st, 2, 3, . . . (n-1)-th) second constructions, and the n-th circle disposed respectively on an imaginary straight line.

27. Method for supporting to make an invention of claim 26 wherein second constructions are obtained from patent publications.

28. Method for supporting to make an invention comprising:
step for determining a first construction having a plurality of indispensable elements;
step for generalizing a plurality of times said first construction to determine successively a plurality of second constructions;
step for selecting at least two constructions from the first construction and said plurality of second constructions; and
step for forming an invention space based on the selected at least two constructions.

29. Method for supporting to make an invention of claim 28 wherein the two constructions are constructions obtained by generalization.
